(19) United States
(12) Patent Application Publication
(10) Pub. No.: US 2016/0262312 A1
(43) Pub. Date: Sep. 15, 2016

(54) Cannabis Trim Station with 5 gallon bucket attachment and strap

(71) Applicant: Trevor J. Ung, Englewood, CO (US)

(72) Inventor: Trevor J. Ung, Englewood, CO (US)

(21) Appl. No.: 14/544,956

(22) Filed: Mar. 9, 2015

(51) Int. Cl. A01G 3/02; B07B 1/02; B65D 25/20

(52) U.S. Cl. CPC A01G 3/02; B65D 25/20; B07B 1/02

(57) ABSTRACT

The invention is four separate plastic injection molded pieces that combines to make a cannabis trim station for the harvesting, trimming, and manicuring of the cannabis flower. Kief is stored under a screen that flips towards a trim storage area. The invention divides the flower and trim by utilizing a divider inside the unit. The invention can also attach to the standard five gallon bucket creating a free standing work station and added storage capacity for the flower and or trim. A strap is attached to the unit to make the whole unit mobile and a walk around working station.

### BACKGROUND

1. Field of Invention

Pertaining to the harvesting and collection of cannabis materials.

2. Discussion of Prior Art

Since commercial cannabis cultivation is a new industry there are few tools and equipment for the harvesting and trimming of the cannabis flower. The other trim products available do not separate flower, trim and kief into separate compartments. My invention provides an ergonomic and mobile work station for the cannabis grower.

Prior art on patents for cannabis harvesting products can not be found.

### OBJECTIVES AND ADVANTAGES

The objective of this invention is to provide a ergonomic trimming work station that properly separates cannabis flower, trim, and kief into designated storage compartments creating a cleaner and more efficient trimming process.

This invention is different from the other because it can attach to a standard 5 gallon bucket, creating more storage volume for cannabis flower and trim, the 5 gallon bucket also creating a stand for the unit to rest on.

The unit can be used with a guitar like strap or harness giving the user a mobile, walk around work station.

### SUMMARY

A cannabis trimming workstation for harvesting and manicuring that is versatile, efficient, and convenient.

### DESCRIPTION OF DRAWINGS

FIG. 1.

Prospective View

FIG. 2.

Top View of Storage Compartment Body

FIG. 3.

Top View Trichom Tray Top Plate

FIG. 4.

Top View Trichome Flip Screen

FIG. 5.

Outside View Butterfly Hinge Door

FIG. 6.

Inside View Butterfly Hinge Door

FIG. 7.

Side View Flower and Trim Divider

FIG. 8.

Side View Bolt, Nut and Washer

FIG. 9.

Prospective View Strap

FIG. 10.

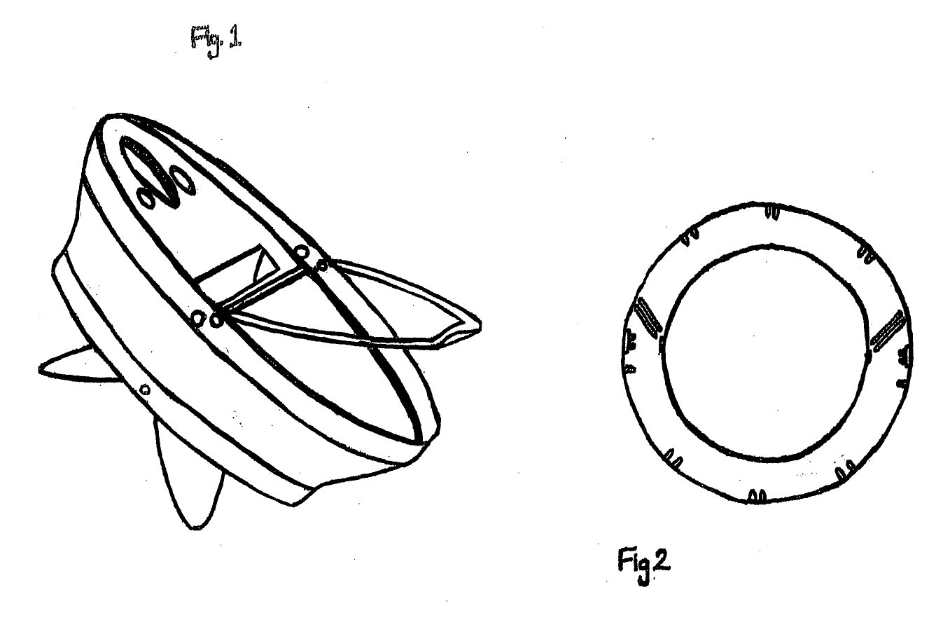

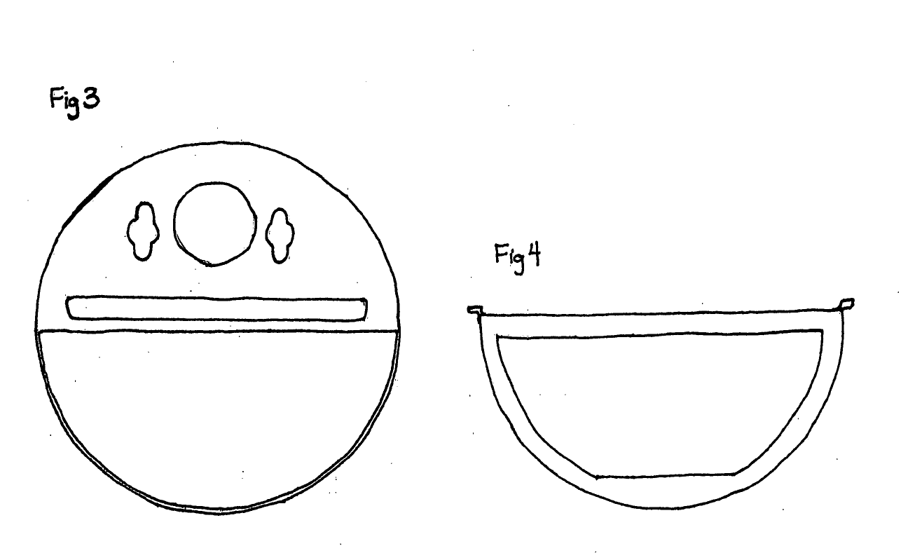

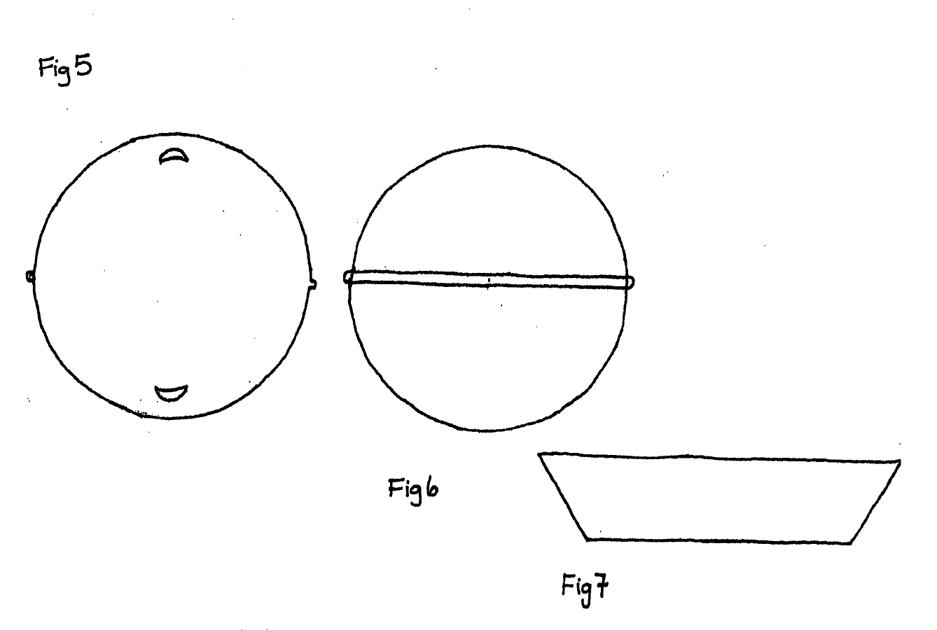

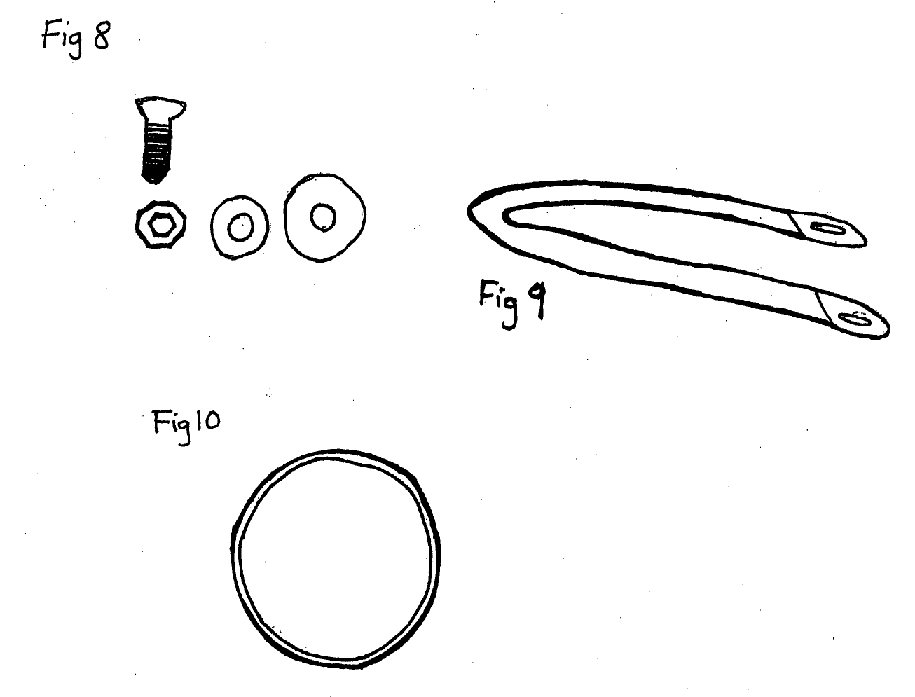

Bottom View Five Gallon Bucket Attachment

### DRAWINGS

1. Storage Compartment Body
2. Butterfly Hinge Doors
3. Divider
4. Trichome Top Plate
5. Trichome Screen
6. Trichome Screen Frame
7. Screen Hinge Swivel Pins
8. Flower Storage Access Hole
9. Trim Storage Access Hole
10. Trichome Tray Top Plate Supports
11. Screen Hinge Swivel Pinholes
12. Strap Bolt Hole
13. Divider Slots
14. Butterfly Door Swivel Pin Left
15. Door Handle Top
16. Door Handle Bottom
17. Bolt with Nut and Washer
18. Strap
19. Pruning Tool Holes
20. Eyelet Holes
21. Kief Storage
22. Five Gallon Bucket Attachment

### LIST OF REFERENCE NUMERALS

### None

### DETAILED DESCRIPTION OF THE INVENTION

The invention consist primarily of plastic that is produced through a plastic injection molding process. The plastic parts combined creates a 3 compartment separator and storage container for separating cannabis flower, trim, and kief during the cannabis harvesting and manicuring process.

The kief is separated from the flower by utilizing a 150 mircom stainless steel screen that collects under a tray below the screen.

The unit easy snaps on the standard 5 gallon bucket creating more storage volume and a stand for the unit to rest on.

The unit also comes with 2 strap bolts to be used with a guitar like strap or harness converting it into a mobile, walk around work station.

The unit consists of five injection molded plastic pieces that snap together. The Storage Compartment Body 1, Is a funnel shaped piece with two Swivel Pin Holes 14, that are located in the bottom rim of the funnel on opposing sides. A pair of Butterfly Hinge Doors 2, snap into the said Swivel Pin Holes 14, in the bottom rim of the Storage Compartment Body 1 by utilizing two pins Right 18, that protrude from each side of the said Butterfly Hinge Doors 2. At the bottom of the unit is the Five Gallon Bucket Attachment 22.

Divider 3, is a flat piece of plastic that divides the flower and trim inside said Body 1. Said Body 1, has two Divider Slots 17, molded into the inside of the funnel of said Body 1, and the said Divider 3, slides into the said Slots 17.

The Trichome Tray Top Plate 4. has two Pruning Tool Holes 22, a Flower Storage Access Hole 8, and Trim Storage Access Hole 9, and the said Top Plate 4, sits inside the top rim of the said Body 1. Inside the rim of said Body 1. are molded Trichome Tray Top Plate Supports 10. Said Top Plate 4, rest on said Plate Supports 10.

Trichome Screen 5. is molded into Trichome Screen Frame 6. Said Screen Frame 6. has two Screen Hinge Swivel Pins 7. that protrude from each side that snap into the Screen Hinge Swivel Pin Holes 11, that are located on the Body, 1. Under the said Screen Frame 6. Kief Storage area is located 21.

In addition to the five plastic molded injection pieces the unit includes a Strap 18. Strap 18, is a cloth like material that has Eyelet Holes 20, on each end that allow Bolt with Nut and Washer 17, to protrude through the Strap 18, and connects through the Strap Bolt Holes 12, that are located next to the said Screen Pinholes 11, on the Body 1.

### OTHER EMBODIMENTS

The parts could possible be made out of other materials besides plastic such as metal or wood.

### OPERATION OF INVENTION

The invention is used when harvesting and trimming of the cannabis plant. The unit has a ergonomic design and can be used; resting on a tabletop, on one's lap or attached to a five gallon bucket and can be used while in the standing or sitting position.

The user trims and manicures the cannabis flower while working over the unit, letting any kief fall through a separation screen and then be stored in the kief storage area. The separation screen retains the excess material trimmed from the flower and then flips up causing the excess trim material to fall through the trim material access hole and into the proper compartment of the storage compartment body while allowing the freshly manicured cannabis flowers to fall into a separate compartment.

There are two pruning tool holes in the Trichome Tray Top where the user stores their pruning scissors and tools for quick and convenient access.

To access and empty the trimmed materials and the trimmed flowers the user opens the butterfly doors on the bottom of the unit allowing them to fall out into another container or you can remove the Trichome Tray Top the access both compartments.

Its a plastic molded apparatus thats comprising of 5 separate plastic pieces. Once combined creating a cannabis trim station that could be attached to a five gallon bucket or any like container that could rest the unit on top or use the container as added volume capacity.

1-7. (canceled)

8. Cannabis trim station comprising: a. 5 gallon bucket attachment for added storage capacity and stand alone work station. b strap attached to the unit making the unit mobile and giving the user the option for a stand up position. c. divider inside the unit to separate small trimmed material from manicured cannabis. d. doors at bottom of the unit to access materials. e. a 150 micron stainless steel screen used to collect kief
